(19) United States
(12) Patent Application Publication
(10) Pub. No.: US 2005/0005523 A1
(43) Pub. Date: Jan. 13, 2005

(54) Shutter

(76) Inventor: Thomas B. Johnston, Lake Worth, FL (US)

Correspondence Address: LOTT & FRIEDLAND, P.A., P.O. BOX 141098, CORAL GABLES, FL, 33114-1098, US

(21) Appl. No.: 10/616,186

(22) Filed: Jul. 9, 2003

(51) Int. Cl. E06B 7/08

(52) U.S. Cl. 49/74.1; 49/92.1

(57) ABSTRACT

The present invention provides a Bahama awning-type shutter with functional louvers that is strong enough to withstand all tropical weather and test standards relating to and including hurricane force winds, while incorporating the user-friendly, easy-opening mechanism of a jalousie, which is capable of moving all of the louvers in unison. This functional louvered Bahama awning-type shutter has the strength to resist hurricane force winds while still allowing the louvers to function.

### FIELD OF INVENTION

The present invention relates generally to a Bahama awning-type shutter with functional louvers that is strong enough to withstand all tropical weather and test standards relating to and including hurricane force winds, while incorporating the user-friendly, easy-opening mechanism of a jalousie, which is capable of moving all of the louvers in unison. This functional louvered Bahama awning-type shutter has the strength to resist hurricane force winds while still allowing the louvers to function.

### BACKGROUND OF THE INVENTION

Tropical window coverings, known as Bahama shutters or awnings, are frequently used to provide shade, security and protection from storm damage for windows in homes. Bahama awnings are made up of a framework with a plurality of horizontal louvers or slats, which are usually fixed at certain angle. The awning attaches to the top of the window frame horizontally by a hinge. The Bahama awning can rotate about the hinge so that the lower portion of the awning can move away from the window. The lower portion of the awning can be held in the open position by telescoping arms. During a storm, the Bahama awning can be lowered to a closed position such that the awning is completely parallel to the window. However, conventional Bahama awnings do not provide adequate protection in a strong tropical event because the protection is structurally limited by the strength of the individual louvers. For hurricane protection, the Bahama awnings must incorporate either a lexan sheet or solid sheet of aluminum to reinforce them for impact resistance.

Jalousie window and door treatments are also well known in tropical climates. Jalousies are typically made up of louvers that extend across and are pivoted in a window frame. To open the louvers, the user actuates an operating mechanism to rotate the louvers outwardly around a horizontal axis. The operating mechanism moves all louvers in unison in the same direction. The louvers are parallel and horizontal when fully open, thereby opening vertical spaces between the louvers for airflow. When closed, the louvers either abut each other or overlap slightly such that upper louvers lap over lower louvers on the outside of the window. Jalousies are used in a variety of locations that may require different needs for ventilation, light transmission, security and appearance. Most often jalousies are used in tropical climates to allow for maximum airflow through the building.

Jalousie window and door treatments generally use a winding crank mechanism to open and close the louvers. The winding crank mechanism uses worm and pinion gears, or the like, whereby the rotation is transformed into translational displacement of a window bar coupled to the louvers. By using the winding crank mechanism, the user can adjust the jalousie's louvers to maintain any desired louver angle. Jalousies may also use a simple bar mechanism, which is attached to all the louvers vertically. The bar mechanism is manually operated by a user to move the louvers to any desired position.

It is desirous for Jalousie doors and windows to resist both positive and negative pressures from both inward and outward wind loads. Generally, inward wind loads or positive pressures cause the louvers of the jalousie to close tighter and thus resist inward wind pressure. However, outward wind loads or negative pressures can cause the louvers to open outwardly, resisted only by the frictional resistance of the operating mechanism, which is typically minimal so that the user can easily open the louvers. Thus, the ease with which the louvers open by outward pressure may be a problem during tropical storms or forced entry.

Hurricane winds are the biggest potential problem facing homeowners in tropical climates. Many homeowners use some sort of hurricane shutter to protect their home's windows. Some of the most common hurricane protection products are: hurricane panels, accordion shutters, Bahama awning shutters, colonial hinged hurricane shutters, and roll down hurricane shutters. Southern Building Code Congress International (SBCCI) certification and the Miami-Dade County Building Code product certification are some of the impact certifications that are currently accepted by the Florida Building Code, one of the strongest building codes for wind in the nation. Impact testing standards, such as South Florida Building Code TA 201, 202, 203; SSTD12; ASTM 1996 and 1886, are used to determine a product's effectiveness against hurricane winds. The “large missile” test is performed by shooting an approximately nine foot long, nine pound 2×4 from an air cannon at 34 mph. This simulates 150 mph wind carrying large debris. Ratings are then given to specify the test load or wind force that the product successfully withstood. These ratings assist the public in making informed decisions about which hurricane protection products they choose for their home.

There is a need to make a Bahama awning-type shutter with functional louvers that is strong enough to withstand all tropical weather, including hurricane force winds, while incorporating the user-friendly, easy-opening mechanism of a jalousie, which is capable of moving all of the louvers in unison.

A reinforced storm shutter as described in U.S. Pat. No. 6,536,174 to Foster et al. ('174 Patent) is an awning-type shutter that contains louvers that are welded at three distinct locations to increase the strength of the shutter. The louvers are rigidly secured to the side members of the frame. This shutter does not allow for all louvers to move simultaneously with each other.

A reinforced shutter structure as described in U.S. Pat. No. 6,543,188 to Poma et al. ('188 Patent) is an awning-type shutter that contains louvers. To enable the shutter to withstand hurricane force winds, the user must insert a rigid support plate into the shutter at the time of the storm. Similarly, the reinforced shutter structure as described in U.S. Pat. No. 5,907,929 to Poma et al. ('929 Patent) is also an awning-type shutter that contains louvers and a removable rigid support plate. Both of these shutters do not provide a unitary Bahama awning-type shutter that protects against hurricane force winds without the need to insert a support member.

An exterior louvered hurricane window shutter as described in U.S. patent application Ser. No. 09/909,571 to Horn et al. describes a shutter that contains functional louvers, however, an impact resistant member is permanently affixed to the shutters framework in order for the shutter to be hurricane resistant. Therefore, this shutter does not provide a Bahama awning-type shutter that protects against hurricane force winds without the need for an additional member to protect the louvers.

The operating assembly as described in U.S. Pat. No. 5,907,926 to Sosa ('926 patent) enables relatively heavy jalousie window louvers and associated moving components to be actuated over a tolerable range of actuating forces. Brakes permit the louvers to be held frictionally at any fixed orientation. Additionally, the operating assembly as described in the continuation-in-part patent, U.S. Pat. No. 6,061,962 to Sosa ('962 patent) includes a secondary lock that acts primarily to prevent opening of the louvers in response to negative or outward pressure such as from a heavy storm or force applied by a burglar. However, these operating mechanisms are not designed to be incorporated into hurricane resistant Bahama awning-type shutters.

A jalousie as described in U.S. Pat. No. 6,378,248 to Jordal ('248 patent) provides for dual panels with independent panel movement. This jalousie allows for the front panels to be made of an opaque material, so as to reflect the sun when needed, and the rear panels to be made of transparent glass. Even though such dual pane jalousie panels provide increased strength and protection, the jalousie is not designed to withstand hurricane force winds.

Further, the jalousie as described in U.S. Pat. No. 4,813,183 to Jordal ('183 patent) provides for a dual louver blade jalousie that provides a window which forms a sealed air chamber when the louver blades are closed which is highly resistant to air and water infiltration and has a high insulation value. Although this jalousie is designed to be resistant to air and water during adverse weather conditions, the jalousie is not designed to be resistant to strong hurricane force winds.

A jalousie as described in U.S. Pat. No. 6,098,339 to Rivera et al. ('339) provides for a reinforced jalousie window with spaced wall side jambs for pivot support. This jalousie construction allows for improved air sealing and improved security from unwanted entry. Even though this jalousie offers greater structural strength, the jalousie is not designed to be resistant to hurricane force winds.

Consequently, there is a need in the art for a Bahama awning-type shutter with functional louvers that is strong enough to withstand all tropical weather, including hurricane force winds, while incorporating the user-friendly, easy-opening mechanism of a jalousie, which is capable of moving all of the louvers in unison.

### SUMMARY OF THE INVENTION

The present invention solves significant problems in the art by providing a Bahama awning-type shutter with functional louvers that is strong enough to withstand all tropical weather, including hurricane force winds, while incorporating the user-friendly, easy-opening mechanism of a jalousie, which is capable of moving all of the louvers in unison.

The above and other objects of the invention are achieved in the embodiments described herein by a shutter providing storm protection having an outer frame formed by a pair of vertical members and a pair of horizontal members connected to each other and defining an interior area. The interior area of the shutter is filled with a plurality of functional horizontal louvers movably connected to the outer frame. Both the outer frame and the louvers are made out of hurricane resistant materials. The louvers of the shutter function by a user actuated operating mechanism, similar to that found in a jalousie, which can be a L-angle, bar, winding crank, or a simple mechanism found on the backside of the frame. When the L-angle is employed, the user simple moves or rotates the L-angle to open or close all the louvers in unison. The shutters may include means for locking the louvers in the closed position during a storm. Additionally, the louvers are designed to interlock with each other in a completely closed position. The shutters are connectable above an external opening in a structure by a hinge, whereby the shutter may be propped open from the bottom by use of a telescoping arm or other similar device. The shutters contain means to hold or fasten the shutter against the structure, protecting the window from hurricane wind damage or intruders.

Accordingly, it is an object of the present invention to provide a shutter for protecting external openings in a structure from hurricane force winds. The shutter has an outer frame formed by a pair of vertical members and a pair of horizontal members connected to each other and defining an interior area. The shutter has at least one hinge, which connects the outer frame of the shutter to a location on the structure adjacent an external opening in the structure. A plurality of functional louvers are movably connected to the outer frame and fill the interior area of the shutter. The outer frame and louvers are made out of materials that are resistant to hurricane force winds. The louvers of the shutter function by a user actuated operating mechanism, similar to that found in a jalousie, which can be a L-angle, bar, winding crank, or a simple mechanism found on the backside of the frame. When the L-angle is employed, the user simple moves or rotates the L-angle connected to the louvers which thereby opens or closes all the louvers in unison. The shutters may include means for locking the louvers in the closed position during a storm. The shutter is movable about the hinge that connects the shutter to the structure and includes means to hold the shutter apart from the structure. A telescoping arm may be used to hold the shutter in place. The shutter includes means to lock the shutter against the structure, protecting the window from hurricane force winds or intruders.

An advantage of the invention is that the Bahama awning-type shutter contains louvers that remain completely functional, while providing protection from hurricane force winds. Additionally, the louvers function in unison with an easy-opening mechanism, similar to the mechanisms used on jalousie windows. This allows the user of the shutter to be able to easily open the louvers on the shutter to vary the amount of light or air entering the building.

### BRIEF DESCRIPTION OF THE DRAWINGS

FIG. 1 is a front view of the shutter according to the invention.

FIG. 2 is a back view of the shutter according to the invention.

FIG. 3 is a cross view of the louver according to the invention.

### DETAILED DESCRIPTION OF THE PREFERRED EMBODIMENT

This invention provides a Bahama awning-type shutter with functional louvers that is strong enough to withstand all tropical weather, including hurricane force winds, while incorporating the user-friendly, easy-opening mechanism of a jalousie, which is capable of moving all of the louvers in unison. While the invention is susceptible of several embodiments, there is shown in the drawings, a specific embodiment thereof, with the understanding that the present disclosure is to be considered as an exemplification of the invention and is not intended to limit the invention to the specific embodiment.

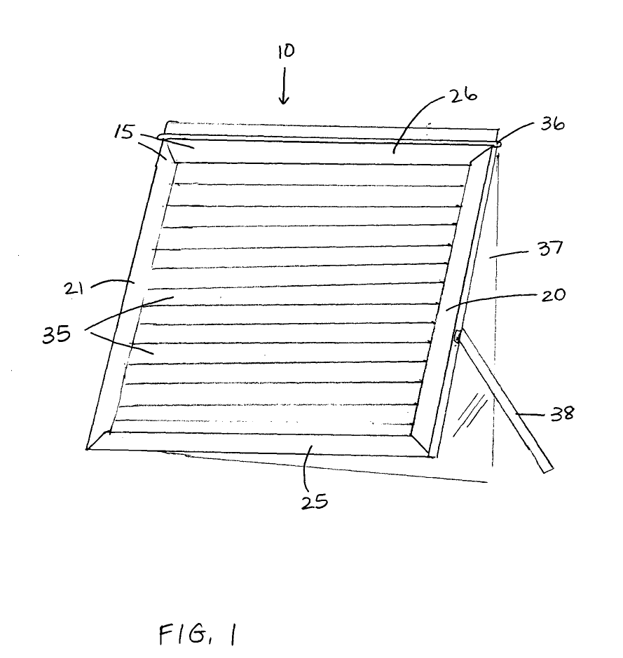

Referring initially to FIG. 1 of the drawings, in which like numerals indicate like elements throughout the several views, an overview of the Bahama awning-type shutter 10 is shown. The Bahama awning-type shutter 10 has an outer frame 15 formed by a pair of vertical members 20 and 21 spaced apart from each other and a pair of horizontal members 25 and 26 spaced apart from each other, where the vertical members 20 and 21 and horizontal members 25 and 26 are connected to each other and define an interior area. The vertical members include a left vertical member 21 and a right vertical member 20. The horizontal members include an upper horizontal member 26 and a lower horizontal member 25. The interior area of the shutter 10 is filled with a plurality of functional horizontal louvers 35 movably connected to the outer frame 15. The louvers 35 are connected to the outer frame 15 by screws, whereby the louvers 35 pivot about the screws. Both the outer frame 15 and the louvers 35 are made out of hurricane resistant materials. The hurricane resistant materials can be aluminum, polycarbonate, high density plastic with foam reinforcement or other materials with similar strength.

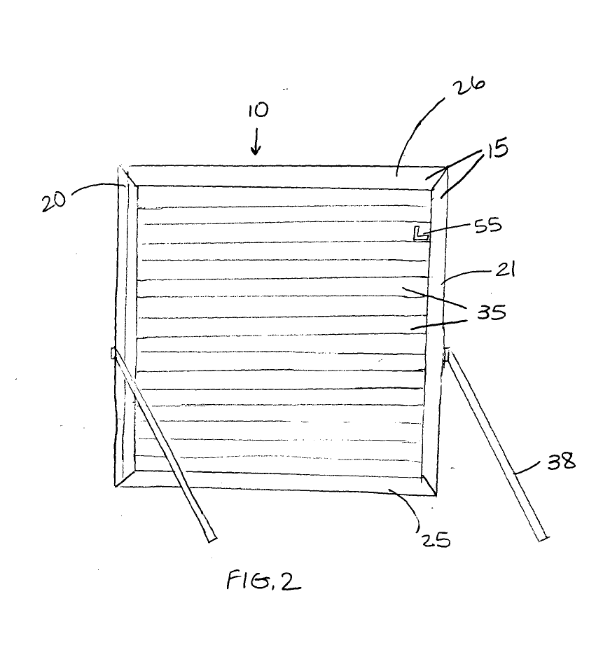

Referring to FIG. 1 and FIG. 2 in combination, the louvers 35 of the shutter 10 function by a user actuated operating mechanism, similar to that found in a jalousie. Generally, jalousie window treatments' operating mechanisms are manually moved or rotated to open or close the louvers 35 as required. The operating mechanism may be a L-angle 55, a bar, a winding crank, a simple sliding mechanism found on the backside of a vertical member 20 or 21 of the outer frame 15, or any other operating mechanism that moves all louvers in unison. When the simple sliding mechanism on the backside of a vertical member 20 or 21 of the outer frame 15 is employed, the user simply moves a vertical sliding mechanism up or down. The vertical sliding mechanism is connected to the vertical member 20 or 21 and in turn opens or closes all the louvers 35 in unison. When the L-angle 55 is employed, the user is able to actuate the louvers 35 by moving the L-angle 55. The L-angle 55 is typically a one-inch by one-inch piece or bracket in the form of the letter “L”. The L-angle 55 can act as a spacer and hold the louvers 35 in the open position or alternately, can be used to lock the louvers 35 in a closed position and lock the shutter 10 over the window 37. The louvers 35 may be opened by manually adjusting one louver 35. When movement of the L-angle 55 rotates one louver 35, the other louvers 35 will move in unison with the louver 35 that is being manually moved. Typically, two L-angles 55 are employed per shutter 10, one L-angle 55 being placed between two louvers 35 next to the outer frame 15. The various embodiments of the operating mechanisms that can be used are all intended to move all of the louvers 35 in unison in the same direction. Thus the louvers 35 can easily be opened or closed, depending on whether the user wants to receive light or air inside the building.

The shutters 10 also include means for locking the louvers 35 in the closed position during a storm. The locking mechanism may be any device that holds the operating mechanism in a fixed position so that the louvers 35 do not rotate. When the L-angle 55 is used as the operating mechanism of the louvers 35, the L-angle 55 can also be used as the locking mechanism to hold the louvers 35 in place and lock the shutter 10 against the window 37. When the louvers 35 are in a closed position and the shutter 10 is rotated toward the window 37, the L-angle 55 will automatically be positioned between the window 37 and the shutter 10. Thus, the user can simply secure the L-angle 55 to the structure near the window 37 and the louvers 35 and the shutter 10 will remain the closed position.

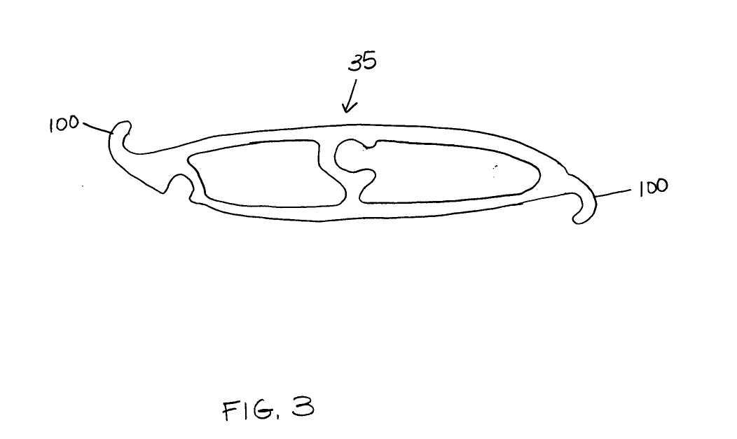

As shown in FIG. 3, the louvers 35 are also designed to interlock with each other in a completely closed position. The louvers 35 interlock by use of a special hook 100 found on opposite edges of each louvers 35 blade's horizontal edge. Viewed as a cross section the louvers 35 are essentially an elliptical shape with a hook 100 at each end facing the opposite direction. When the louvers 35 are closed, the hooks 100 of adjacent louver 35 blades interface such that each louver 35 grasps the louver 35 above and below it. When the louvers 35 are locked in the closed position during a storm, the integrity of the structure of the shutter 10 will be increased by the locking mechanism, the louver 35 hooks 100, and the means used to secure the shutter 10 to the structure. The locked louvers 35 will resist outward wind loads caused by storms or hurricanes and the locking mechanism and the means used to secure the shutter 10 to the structure will prevent the louvers 35 from opening.

Referring to FIG. 1, the Bahama awning-type shutters 10 are connected by a hinge 36 to the surface above an external opening in a structure. Typically, the shutters 10 are connected by a hinge 36 that attaches the outer frame 15 to just above the opening of the window 37. The shutter 10 is movably connected to the hinge 36 such that the lower portion of the shutter 10 may be moved apart from the structure in an arc relative to the hinge 36, thus becoming a type of awning. The shutter 10 usually overlaps the window 37 on all sides in order to provide adequate protection to the window 37. The shutter 10 can be positioned at some desired angle relative to the window 37. The shutter 10 may be propped open from the bottom or side by use of a telescoping arm 38 or another similar support device used to hold the shutter 10 apart from the structure. When the shutter 10 is propped open, light and air are able to enter the building. Thus, the Bahama awning-type shutters 10 of this invention allow light and air to enter a building by two ways, one way is through the louvers 35 when they are open and the second way is through the bottom or sides of the awning when it is propped open and away from the structure.

The shutter 10 also contains a means to hold the shutter 10 against the window 37 in a closed position. The means used to hold the shutter 10 against the structure over the window 37 may be a L-angle 55 at the bottom of the shutter 10, a Z bar extending horizontally across the backside of the shutter 10, predrilled holes through the outer frame 15 which are anchored by bolts to the structure near the window 37, a separate bracket on the wall, or spring loaded arms on the shutter 10 that fit into predrilled holes in the structure near the window 37. The means used to hold the shutter 10 against the structure allows for protection of the window 37 from wind damage or intruders and provides shade inside the building.

Accordingly, it will be understood that the preferred embodiment of the present invention has been disclosed by way of example and that other modifications and alterations may occur to those skilled in the art without departing from the scope and spirit of the appended claims. Those skilled in the art will understand that this invention could be used in various ways to build hurricane resistant shutters with functional louvers. For example, a Bahama awning-type shutter could be made to include a mullion in the middle of the louvers. Thus, both sides of shutter would contain independently functioning louvers, while still retaining hurricane resistance. Any number of mullions could be added to the Bahama awning-type shutter of this invention in order to extend the length of the shutter, while still retaining the functioning louvers of this invention.

1. A shutter providing storm protection comprising:
an outer frame formed by a pair of vertical members and a pair of horizontal members connected to each other and defining an interior area;
a plurality of functional horizontal louvers movably connected to said outer frame and substantially filling said interior area of said frame; and
wherein said outer frame and said louvers are made out of a hurricane resistant material.

2. The shutter of claim 1 wherein said louvers function by a user actuating an operating mechanism, which rotates said louvers in unison outwardly around a horizontal axis.

3. The shutter of claim 2 wherein said operating mechanism is at least one L-angle.

4. The shutter of claim 2 wherein said operating mechanism is a vertical sliding mechanism on a backside of said vertical member of said outer frame.

5. The shutter of claim 2 wherein said operating mechanism is a bar extending vertically across said louvers.

6. The shutter of claim 2 wherein said operating mechanism is a winding crank mechanism.

7. The shutter of claim 1 further including means for locking said louvers into a closed position.

8. The shutter of claim 7 wherein said means for locking said louvers into a closed position is a mechanism on a backside of said vertical member of said outer frame.

9. The shutter of claim 7 wherein said means for locking said louvers into a closed position is at least one L-angle.

10. The shutter of claim 1 wherein said louvers interlock horizontally with each other when said louvers are in a closed position.

11. The shutter of claim 1 wherein said hurricane resistant material is aluminum.

12. The shutter of claim 1 wherein said hurricane resistant material is polycarbonate.

13. The shutter of claim 1 wherein said hurricane resistant material is high density plastic with foam reinforcement.

14. The shutter of claim 1 further including means for holding said shutter against a window or an opening.

15. The shutter of claim 14, wherein said means for holding said shutter against said window or said opening is at least one L-angle.

16. The shutter of claim 14, wherein said means for holding said shutter against said window or said opening is a Z bar.

17. The shutter of claim 14, wherein said means for holding said shutter against said window or said opening are predrilled holes through an outer frame which are anchored by bolts to a structure near said window.

18. The shutter of claim 1 wherein said pair of horizontal members includes an upper member and a lower member, said upper horizontal member being connectable above an external opening in a structure by at least one hinge, wherein said shutter is movable about said at least one hinge.

19. The shutter of claim 18 further including means for holding said lower horizontal member of said shutter apart from said structure.

20. The shutter of claim 18, wherein said means for holding said lower horizontal member of said shutter is a telescoping arm.

21. A shutter for protecting external openings in a structure from hurricane force winds comprising:
an outer frame formed by a pair of vertical members and a pair of horizontal members connected to each other and defining an interior area;
at least one hinge connecting said outer frame to said structure adjacent to said external opening;
a plurality of functional horizontal louvers movably connected to said outer frame and substantially filling said interior area of said frame; and
wherein said outer frame and said louvers are made out of a material resistant to hurricane force winds.

22. The shutter of claim 21 wherein said louvers function by a user actuating an operating mechanism, which rotates said louvers in unison outwardly around a horizontal axis.

23. The shutter of claim 22 wherein said operating mechanism is at least one L-angle.

24. The shutter of claim 22 wherein said operating mechanism is a vertical sliding mechanism on a backside of said vertical member of said outer frame.

25. The shutter of claim 22 wherein said operating mechanism is a bar extending vertically across said louvers.

26. The shutter of claim 22 wherein said operating mechanism is a winding crank mechanism.

27. The shutter of claim 21 further including means for locking said louvers into a closed position.

28. The shutter of claim 27 wherein said means for locking said louvers into a closed position is a mechanism on a backside of said vertical member of said outer frame.

29. The shutter of claim 27 wherein said means for locking said louvers into a closed position is at least one L-angle.

30. The shutter of claim 21 wherein said louvers interlock horizontally with each other when said louvers are in a closed position.

31. The shutter of claim 21 wherein said louvers interlock horizontally with each other when said louvers are in a closed position and pressure is applied to said louvers.

32. The shutter of claim 21 wherein said material resistant to hurricane force winds is aluminum.

33. The shutter of claim 21 wherein said material resistant to hurricane force winds is polycarbonate.

34. The shutter of claim 21 wherein said material resistant to hurricane force winds is high density plastic with foam reinforcement.

35. The shutter of claim 21 wherein said shutter is movable about said at least one hinge.

36. The shutter of claim 21 further including means for holding said shutter apart from said structure.

37. The shutter of claim 21, further including a telescoping arm to hold said lower horizontal member of said shutter apart from said structure.

38. A hurricane shutter comprising:
an outer frame forming an interior area,
a plurality of louvers extending horizontally across said interior area,
at least one L-angle movably connected between two of said louvers,
wherein said L-angle functions to actuate said louvers, lock said louvers in a closed position and hold said shutter against a window, and
wherein said outer frame and said louvers are made of a hurricane resistant material.

39. The shutter of claim 38 wherein said louvers interlock horizontally with each other when said louvers are in a closed position.

40. The shutter of claim 38 wherein said hurricane resistant material is aluminum.

41. The shutter of claim 38 wherein said hurricane resistant material is polycarbonate.

42. The shutter of claim 38 wherein said hurricane resistant material is high density plastic with foam reinforcement.

43. The shutter of claim 38 wherein said outer frame includes an upper horizontal member and a lower horizontal member, said upper horizontal member being connectable above an external opening in a structure by at least one hinge, wherein said shutter is movable about said at least one hinge.

44. The shutter of claim 43 further including means for holding said lower horizontal member of said shutter apart from said structure.

45. The shutter of claim 43, wherein said means for holding said lower horizontal member of said shutter is a telescoping arm.
